(19) United States
(12) Patent Application Publication
(10) Pub. No.: US 2025/0138403 A1
(43) Pub. Date: May 1, 2025

(54) Light Projection Device

(71) Applicant: T.Q. OPTOELECTRONICS. CO., LTD., Tainan City (TW)

(72) Inventors: Ji-Pin Wang, Tainan City (TW); Huan-Ping Chiu, Tainan City (RW); Shu-Shi Li, Tainan City (TW)

(21) Appl. No.: 18/914,319

(22) Filed: Oct. 14, 2024

(30) Foreign Application Priority Data
Oct. 27, 2023 (TW) 112141265

(51) Int. Cl. G03B 21/00; G03B 21/20

(52) U.S. Cl. CPC G03B 21/008; G03B 21/2066; G03B 21/208

(57) ABSTRACT

The present application reveals a light projection device, in which part of beam is projected from a light source module to a digital micromirror device. A light expansion module above the digital micromirror device receives part of the beam reflected from the digital micromirror device for projection. A light projection range of the light projection device is larger than a light projection range of the digital micromirror device. When part of the beam is projected from the light source module to both sides of the digital micromirror device, part of the beam is projected to the light expansion modules disposed on both sides of the digital micromirror device for reflection, and hence making light be used effectively and providing a lighting device with a wide angle of lighting.

### FIELD OF THE INVENTION

The invention relates to a light projection device, particularly a light projection device with an expanded light projection range.

### BACKGROUND OF THE INVENTION

Headlights include direction lights, low beams, high beams, and so on. The use and design of the headlights are regulated by relevant laws and regulations and cannot be set or modified by will to avoid causing trouble to other passers. For example, the light pattern of low beams must be designed to have a clear cutoff line between dark and light, and the height of the cutoff line must be lower than the height of the drivers' eyes in oncoming vehicles to prevent excessive light from directly shining into the drivers' eyes in the oncoming vehicles or causing glare that affects driving safety. Furthermore, the brightness and illumination distance of high beams are greater than that of low beams. Therefore, high beams cannot be used when meeting an oncoming vehicle or when there is a vehicle within 100 meters in front.

### SUMMARY OF THE INVENTION

An objective of the present application is to reduce the waste of the light not projecting to the digital micromirror device caused by the determination of a light source with a lighting range capable of encompassing the whole digital micromirror device, and to increase the light projection range of a light projection device simultaneous with high and low beams.

To achieve objective, the present application provides a light projection device, which comprises a first light source module and a digital micromirror device. The first light source module projects a first beam to the digital micromirror device. The digital micromirror device reflects the first beam to a first lens set for projecting a first light pattern. The present application is characterized by comprising a first light expansion module receiving part of the first beam reflected by the digital micromirror device. The first light expansion module projects a second light pattern at a side of the first light pattern.

The present application further provides another light projection device, which comprises at least one second light source module and a digital micromirror device. The at least one second light source module projects at least one second beam to the digital micromirror device. The digital micromirror device reflects the at least one second beam to a first lens set for projecting a third light pattern. The light projection device further comprises at least one second light expansion module disposed on a side of the digital micromirror device and receiving part of the at least one second beam of the at least one second light source module. The at least one second light expansion module projects a fourth light pattern at a side of the third light pattern.

### BRIEF DESCRIPTION OF DRAWINGS

FIG. 1 shows an exploded view according to the first embodiment of the present application;

FIG. 2A shows a first schematic diagram of the light source module projecting beam according to the first embodiment of the present application;

FIG. 2B shows a second schematic diagram of the light source module projecting beam according to the first embodiment of the present application;

FIG. 3A shows a side view of the light path according to the first embodiment of the present application;

FIG. 3B shows a top view of the light path according to the first embodiment of the present application;

FIG. 4 shows a side view of the light path of the light expansion module according to the first embodiment of the present application;

FIG. 5 shows the light pattern of the high beam according to the first embodiment of the present application;

FIG. 6A shows a schematic diagram of the vertical angle between the optic axis and the light source module;

FIG. 6B shows a schematic diagram of the horizontal angle between the optic axis and the light source module;

FIG. 7 shows an exploded view according to the second embodiment of the present application;

FIG. 8 shows a side view of the light path of the light expansion module according to the second embodiment of the present application;

FIG. 9 shows the light pattern of the low beam according to the second embodiment of the present application;

FIG. 10A shows a first schematic diagram of two light source modules projecting beam on the digital micromirror device according to the present application;

FIG. 10B shows a second schematic diagram of two light source modules projecting beam on the digital micromirror device according to the present application; and

FIG. 10C shows a third schematic diagram of two light source modules projecting beam on the digital micromirror device according to the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

According to the prior art, when a light source such as laser is projected to a digital micromirror device for reflection, in order to maximize a light pattern reflected by the digital micromirror device, the light source projected to the digital micromirror device must encompass the whole digital micromirror device. To do this, the lighting range of the light source must be larger than the lighting range of the digital micromirror device. Consequently, part of the light projected to the digital micromirror device cannot be reflected and thus resulting in waste. Therefore, a structure is needed to reduce the waste of light.

The present application provides a light projection device. A light expansion module is disposed above a digital micromirror device. After the beam from a light source is projected to the digital micromirror device, part of the projected beam is reflected to the light expansion module for projection. Wherein when the beam is projected to digital micromirror device, the beam not projected to the digital micromirror will be reflected by the light expansion module disposed on both sides of the digital micromirror device for reducing waste of light and providing a wide angle lighting.

In the following description, various embodiments of the present application are described using figures for describing the present application in detail. Nonetheless, the concepts of the present application can be embodied by various forms. Those embodiments are not used to limit the scope and range of the present application.

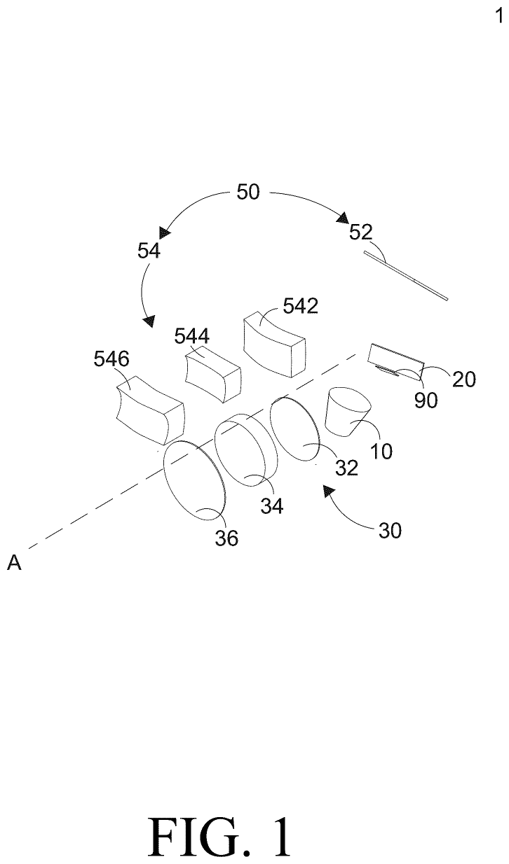

First, please refer to FIG. 1, which shows an exploded view according to the first embodiment of the present application. A light projection device 1 comprises a first light source module 10, a digital micromirror device 20, a first lens set 30, and a first light expansion module 50. The first lens set 30 includes a first lens 32, a second lens 34, and a third lens 36. The first light expansion module 50 includes a second reflection member 52 and a second lens set 54. The second lens set 54 includes a fourth lens 542, a fifth lens 544, and a sixth lens 546. The light source of the light projection device 1 according to the present embodiment is a single light source module, the first light source module 10. Nonetheless, the present application is not limited to the embodiment. The light source can be an LED lamp or laser. The first lens 32 and the third lens 36 are double-convex lenses. The second lens 34 and the fifth lens 544 are concavo-convex lenses. The sixth lens 546 is a double-concave lens.

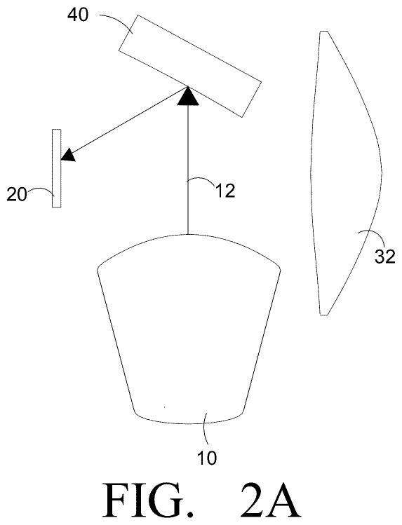

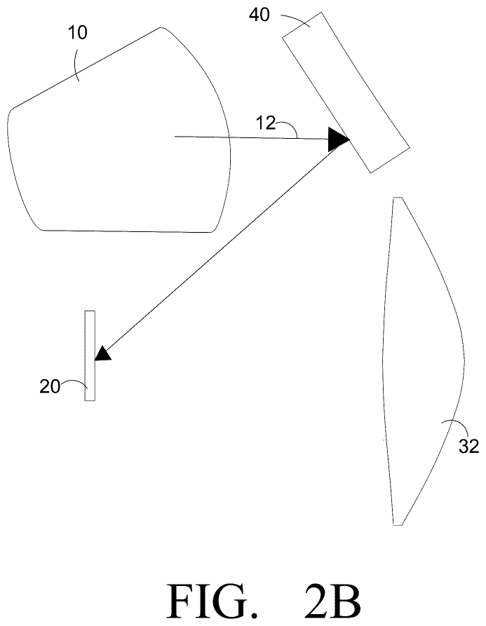

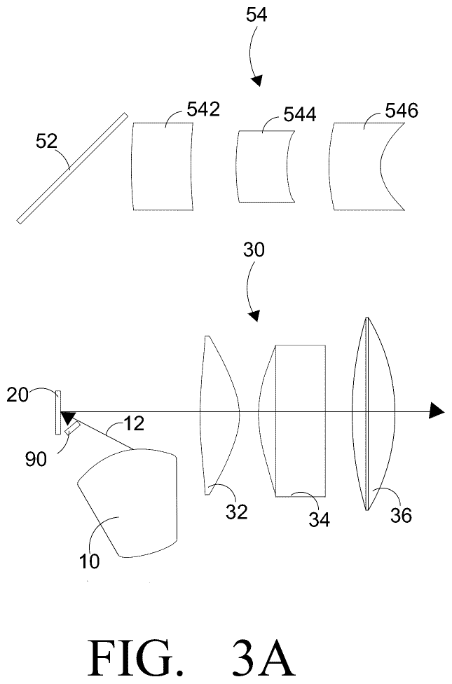

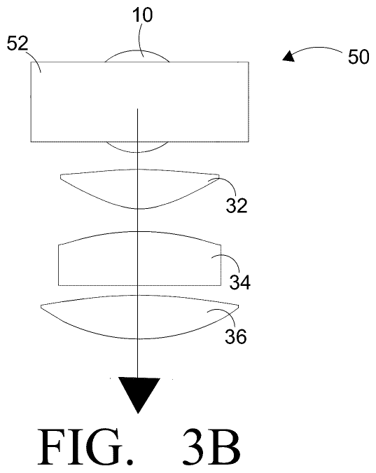

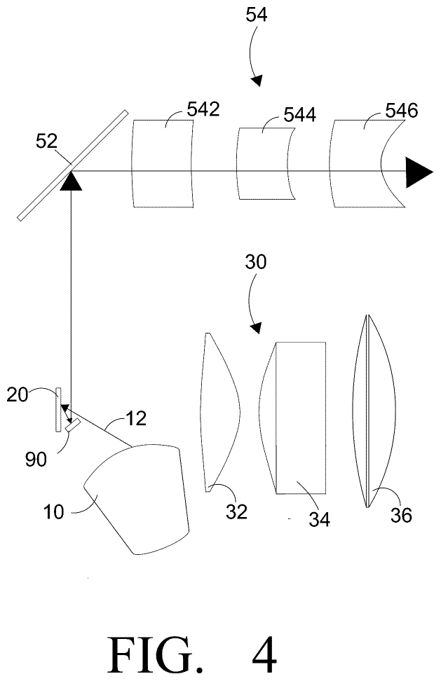

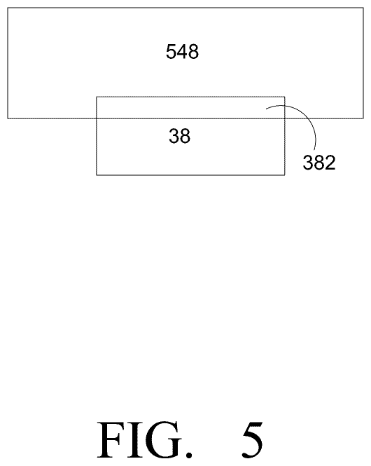

Please refer to FIG. 2A, FIG. 2B, FIG. 3A, FIG. 3B, FIG. 4, and FIG. 5. FIG. 2A shows a first schematic diagram of the light source module projecting beam according to the first embodiment of the present application; FIG. 2B shows a second schematic diagram of the light source module projecting beam according to the first embodiment of the present application; FIG. 3A shows a side view of the light path according to the first embodiment of the present application; FIG. 3B shows a top view of the light path according to the first embodiment of the present application; FIG. 4 shows a side view of the light path of the light expansion module according to the first embodiment of the present application; and FIG. 5 shows the light pattern of the high beam according to the first embodiment of the present application. The first light source module 10 projects a first beam 12 to the digital micromirror device 20. Alternatively, the first light source module 10 can project the first beam 12 to a first reflection member 40 and then the first reflection member 40 reflects the first beam 12 to the digital micromirror device 20. There are two methods to do so. The first method is that the first light source module 10 is disposed on a side of the digital micromirror device 20. The first reflection member 40 is disposed on the other side of the digital micromirror device 20. The first reflection member 40 reflects the first beam 12 of the first light source module 10 to the digital micromirror device 20. The second method is that the first light source module 10 and the first reflection member 40 are disposed on a side of the digital micromirror device 20. The first reflection member 40 reflects the first beam 12 of the first light source module 10 to the digital micromirror device 20. Then, the digital micromirror device 20 reflects the first beam 12 to the first lens set 30 for projecting a first light pattern 38. Part of the first beam 12 reflected by the digital micromirror device 20 is reflected by a fourth reflection member 90 located on a side of the digital micromirror device 20 to the first light expansion module 50. After the first light expansion module 50 receives the part of the first beam 12 reflected by the digital micromirror device 20, the second reflection member 52 reflects the first beam 12 to the second lens set 54. The second lens set 54 projects a second light pattern 548 to a side of the first light pattern 38. A first overlapping region 382 is formed between the first light pattern 38 and the second light pattern 548. The first overlapping region 382, the first light pattern 38, and the second pattern 548 form a high-beam light pattern and thus achieving the effect of increasing the illumination range.

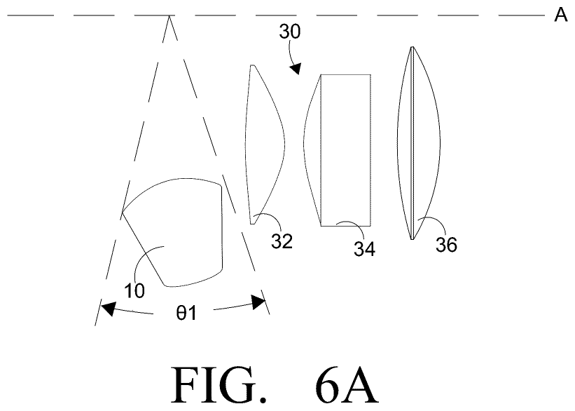

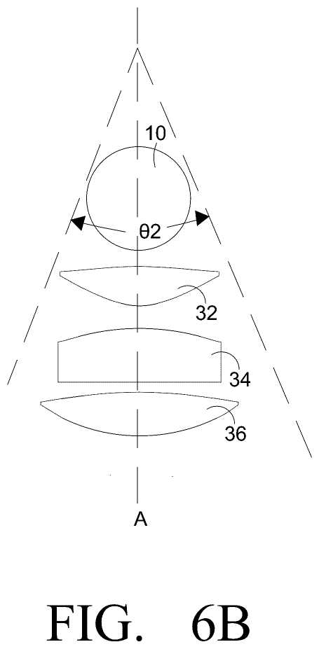

Please refer to FIG. 6A and FIG. 6B, which show schematic diagrams of the vertical angle and the horizontal angle between the optic axis and the light source module. According to the present embodiment, the first light source module 10 is disposed within the angle θ1 of 15˜30 degrees perpendicular to the optic axis and within the angle θ2 of 30˜50 degrees parallel with the optic axis.

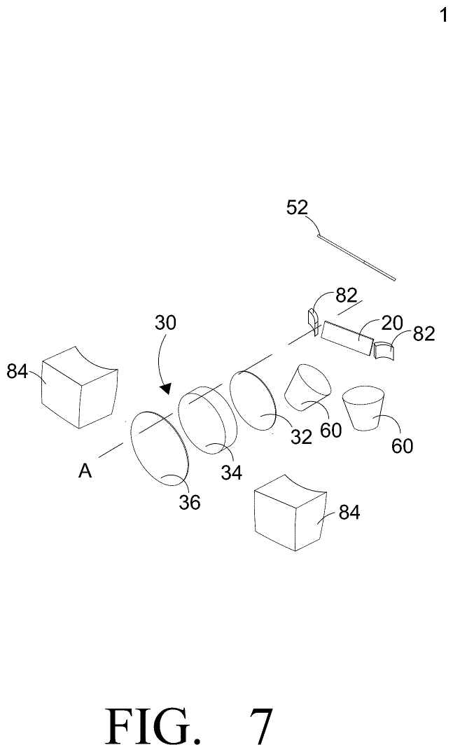

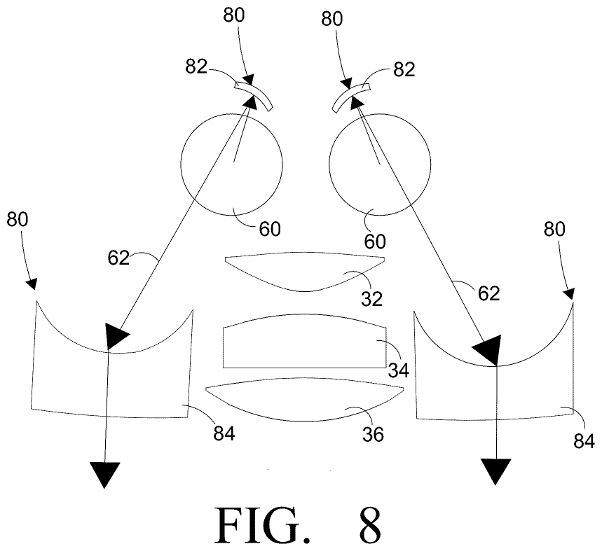

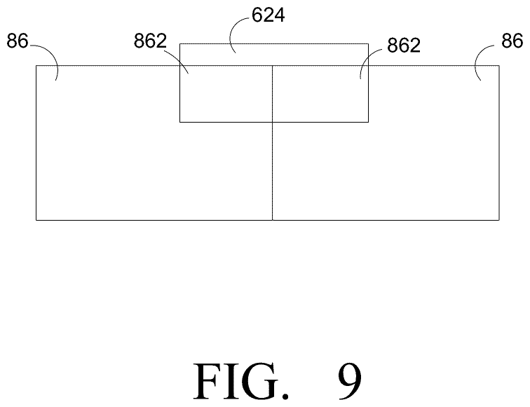

Please refer to FIG. 7, FIG. 8, and FIG. 9, and to FIGS. 2A and 2B again. FIG. 7 shows an exploded view according to the second embodiment of the present application; FIG. 8 shows a side view of the light path of the light expansion module according to the second embodiment of the present application; and FIG. 9 shows the light pattern of the low beam according to the second embodiment of the present application. The light projection device 1 according to the second embodiment comprises at least one second light source module 60 and the digital micromirror device 20. The at least one second light source module 60 projects at least one second beam 62 to the digital micromirror device 20. The portion the same as the first embodiment will not be repeated. The digital micromirror device 20 reflects the at least one second beam 62 to a first lens set 30 for projecting a third light pattern 624. The light projection device 1 further comprises at least one second light expansion module 80 disposed on a side of the digital micromirror device 20 and used for receiving part of the at least one second beam 62 of the at least one second light source module 60. The at least one second light expansion module 80 projects a fourth light pattern 86 on a side of the third light pattern 624. A second overlapping region 862 is formed between the third light pattern 624 and the fourth light pattern 86. The second overlapping region 862, the third light pattern 624, and the fourth light pattern 86 form a low-beam light pattern. The at least one second light expansion module 80 includes a third reflection member 82 and a third lens set 84. The third lens set 84 includes a light concentrating device, a light-pattern expansion device, and a ground illumination device (not shown in the figures). According to the present embodiment, the two light source modules and the two light expansion modules are adopted. Nonetheless, the number of light source modules and light expansion modules are not limited to the preset embodiment. The light source of the light projection device 1 can be an LED lamp or laser. The light projection device 1 owns a wide angle illumination, and effects of enabling effective utilization of the light not projected to the digital micromirror device 20, reducing the waste of light, and increasing the illumination range.

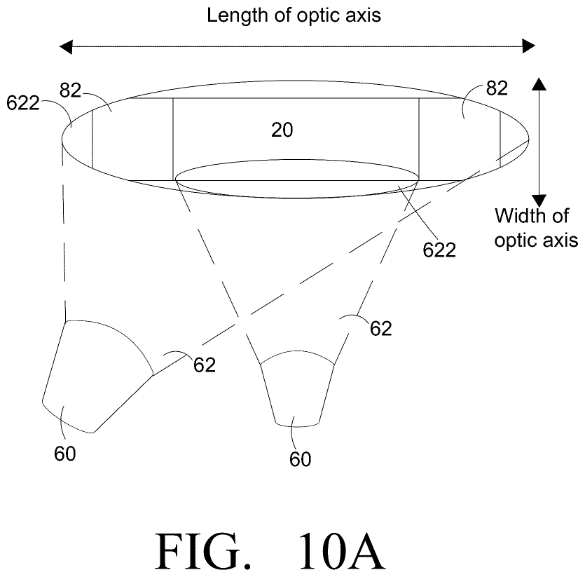

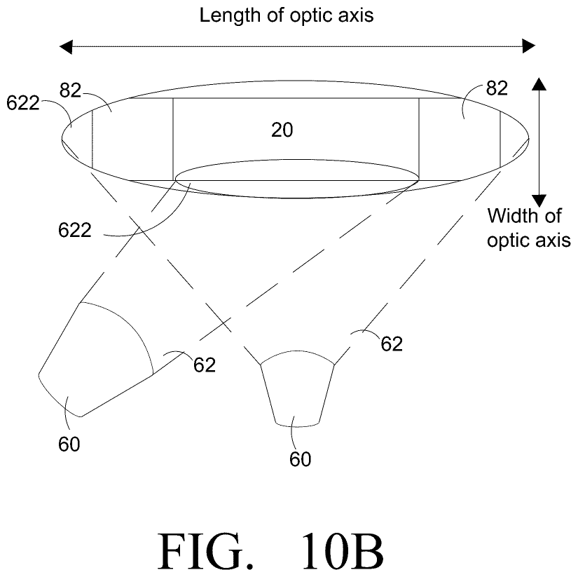

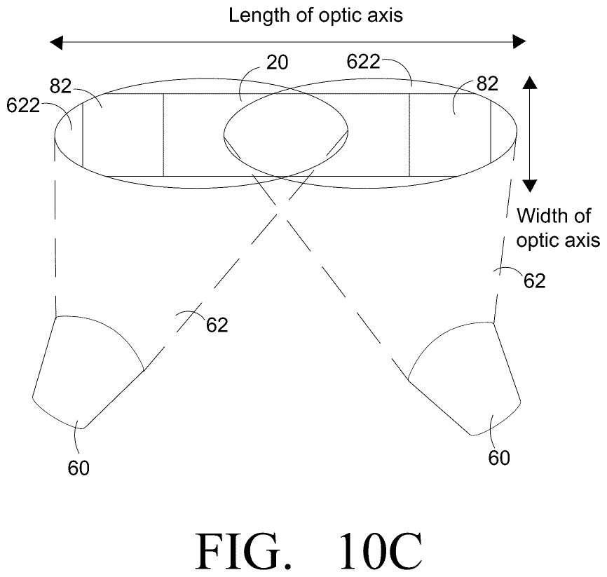

Please refer to FIG. 10A, FIG. 10B, and FIG. 10C, and to FIGS. 6A and 6B again. FIG. 10A shows a first schematic diagram of two light source modules projecting beam on the digital micromirror device according to the present application; FIG. 10B shows a second schematic diagram of two light source modules projecting beam on the digital micromirror device according to the present application; and FIG. 10C shows a third schematic diagram of two light source modules projecting beam on the digital micromirror device according to the present application. According to the present embodiment, the relative positions between the at least one second light source module 60 and the optical axis A is the same as the first embodiment. Hence, the details will not be repeated. When the at least one second beam 62 is projected to the digital micromirror device 20, a light speckle 622 with the size greater than the light control region of the digital micromirror device 20 by 10˜60 percentage. The ratio of the length of the optic axis to the width of the optic axis is from 2:1 to 5:1.

The first embodiment and the second embodiment according to the present application can be combined for usage. The efficacy is the total of the two embodiments. The details will not be described further.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A light projection device, comprising a first light source module and a digital micromirror device, the first light source module projecting a first beam to the digital micromirror device, the digital micromirror device reflecting part of the first beam to a first lens set for projecting a first light pattern, characterized by comprising:
a first light expansion module, receiving part of the first beam reflected by the digital micromirror device, and the first light expansion module projecting a second light pattern at a side of the first light pattern.

2. The light projection device of claim 1, wherein the first light source module is disposed on a side of the digital micromirror device, a first reflection member is disposed on an other side of the digital micromirror device, and the first beam projected from the first light source module is reflected by the first reflection member for projecting to the digital micromirror device.

3. The light projection device of claim 1, wherein the first light source module and a first reflection member are disposed on a side of the digital micromirror device, and the first beam projected from the first light source module is reflected by the first reflection member for projecting to the digital micromirror device.

4. The light projection device of claim 1, wherein the first light source module is disposed within an angle of 30-50 degrees parallel with an optic axis of the light projection device and within an angle of 15-30 degrees perpendicular to the optic axis.

5. The light projection device of claim 1, wherein a first overlapping region is formed between the first light pattern and the second light pattern, and the first overlapping region, the first light pattern, and the second pattern form a high-beam light pattern.

6. The light projection device of claim 1, wherein the first light expansion module includes a second reflection member and a second lens set.

7. A light projection device, comprising at least one second light source module and a digital micromirror device, the at least one second light source module projecting at least one second beam to the digital micromirror device, the digital micromirror device reflecting the at least one second beam to a first lens set for projecting a third light pattern, and further comprising at least one second light expansion module disposed on a side of the digital micromirror device and receiving part of the at least one second beam from the at least one second light source module, and the at least one second light expansion module projecting a fourth light pattern at a side of the third light pattern.

8. The light projection device of claim 7, wherein the at least one second light expansion module includes a third reflection member and a third lens set.

9. The light projection device of claim 7, wherein the at least one second light source module is disposed on a side of the digital micromirror device; a first reflection member is disposed on the other side of the digital micromirror device; and the at least one second beam of the at least one second light source module is reflected by the first reflection member and projected to the digital micromirror device.

10. The light projection device of claim 7, wherein the at least one second light source module and a first reflection member are disposed on a side of the digital micromirror device; and the at least one second beam of the at least one second light source module is reflected by the first reflection member and projected to the digital micromirror device.

11. The light projection device of claim 7, wherein the at least one second light source module is disposed within the angle parallel with the optic axis of 30˜50 degrees and within the angle perpendicular to the optic axis of 15˜30 degrees.

12. The light projection device of claim 7, wherein when the at least one second beam is projected to the digital micromirror device, a light Speckle with the size greater than the light control region of the digital micromirror device by 10˜60 percentage; and the ratio of the length of the optic axis to the width of the optic axis is between 2:1 and 5:1.

13. The light projection device of claim 7, wherein a second overlapping region is formed between the third light pattern and the fourth light pattern; and the second overlapping region, the third light pattern, and the fourth pattern form a low-beam light pattern.
